(19) United States
(12) Patent Application Publication
(10) Pub. No.: US 2015/0152253 A1
(43) Pub. Date: Jun. 4, 2015

(54) FUNCTIONALIZED-ESBR WITH ACRYLATE FUNCTIONAL BASE GROUP

(71) Applicants: Jaroslaw Rogoza, Kielszow (PL); Jindrich Kinkal, Kralupy nad Vltavou (CZ)

(72) Inventors: Jaroslaw Rogoza, Kielszow (PL); Jindrich Kinkal, Kralupy nad Vltavou (CZ)

(73) Assignee: SYNTHOS S.A., 32-600 Oswiecim (PL)

(21) Appl. No.: 14/374,540

(22) PCT Filed: Mar. 22, 2012
(86) PCT No.: PCT/EP2012/001265

§ 371 Date: Feb. 9, 2015

Related U.S. Application Data
(60) Provisional application No. 61/599,501, filed on Feb. 16, 2012.

(51) Int. Cl. C08L 9/06

(52) U.S. Cl. CPC C08L 9/06; C08L 2205/02

(57) ABSTRACT

Various compounds with improved compound properties are disclosed. In one embodiment functionalized emulsion styrene butadiene rubbers (FE-SBR) are disclosed with the functional group of the FE-SBR utilizing a broad range of esters or acrylates. This FE-SBR is then combined effectively with silica based formulations to yield improved properties in rubber articles such as tires.

### FIELD OF THE INVENTION

Various compounds with improved compound properties are disclosed. In one embodiment functionalized emulsion styrene butadiene rubbers (FE-SBR) are disclosed with the functional group of the FE-SBR utilizing a broad range of esters or acrylates. This FE-SBR is then combined effectively with silica based formulations to yield improved properties in rubber articles such as tires.

### BACKGROUND OF THE INVENTION

Emulsion polymerized styrene-butadiene rubber (ESBR or E-SBR) is one of the most widely used polymers in the world today. The emulsion polymerization process has several advantages. It can normally be used under what are considered mild reaction conditions that are tolerant to water and requires only the absence of oxygen. The process is fairly robust to impurities and amenable to using a range of functionalized and non-functionalized monomers. The cost effective process provides a high-solids content with low reaction viscosity with the physical state of the emulsion (colloidal) system allowing for relatively easy control of the process. For further background on emulsion SBR and the “standard recipe” see The Vanderbilt Rubber Handbook. Fourteenth Edition, Pgs 565-576.

Vehicle tires, in particular pneumatic tires, typically are composed of multiple components, each serving a specific and unique function, yet all functioning as one to produce the desired performance. The most common and widely known component being the tire tread which typically contains a rubber/elastomer. The tread typically includes the pattern one associates with wet handling of the tire. Equally important is the tread compound which provides a significant portion of the tires behavior. However ESBR in its present state (such as ESBR-1500 and ESBR1502) has excellent wear and traction but insufficient behavior toward fuel economy (also known as rolling resistance). Blends can often be utilized for the tread component. Examples include blends of 1,4-polybutadiene and styrene/butadiene in varying rations to affect various tire properties such as wet traction, dry traction, treadwear or rolling resistance. Rolling resistance is the resistance that occurs when a round object such as a ball or tire rolls on a flat surface, in steady velocity straight line motion. The resistance is caused mainly by the deformation of the object, the deformation of the surface, or both.

During the 1990's tire manufacturers found increasing success with the implementation of silica into tire treads. By utilizing various levels of silica in place of their standard carbon blacks, tire manufactures were able to significantly lower the tires rolling resistance and improve its wet traction, dry traction, handling and cornering. This in turn led to better safety and fuel economy for the vehicle. One tire company led the efforts with the use of silica and solution styrene butadiene rubbers (SSBR). SSBRs however are typically more expensive than ESBR's, and thus tire manufacturers continued to develop their tire compounds to utilize the advantages seen with silica and still maintain a cost effective price. In addition, silica typically offers lower treadwear, further frustrating the delicate tradeoff seen in tire compounding.

Functional groups are specific groups of atoms within a molecular chain that are responsible for the characteristic chemical reactions of those molecules. The same functional group can undergo the same or similar chemical reaction(s) regardless of the size of the molecule it is a part of, however its relative reactivity can be modified by nearby functional groups. Functional groups that contain carbon-oxygen bonds (C—O) possess different reactivity based upon the location and hybridization of the C—O bond, owing to the electron-withdrawing effect of sp hybridized oxygen (carbonyl groups) and the donating effects of sp² hybridized oxygen (alcohol groups). Examples of oxygen containing functional groups include alcohols, ketones, aldehydes, esters, and ethers. Oxygenated compounds are hydrophobic and are compatible with polar fillers such as silica. Such interaction may be via loose hydrogen bonding or chemical reaction with silica. U.S. Patent Application No. 2002/0061955, U.S. Pat. No. 7,671,128, and European Patent Application 1,935,936, 1,930,184 and 1,308,318 all detail the use of a functional monomer with an ESBR, which is an improvement over the use of (non-functionalized) ESBR alone. Some of these applications include use as tire treads. One functional monomer of choice includes the use of an alcohol or ether group. This approach lacks the chemical reaction with the silica with the loose hydrogen bonding altering the rolling resistance and wear tradeoffs needed. The drawbacks of using an alcohol or ether involve the loose interaction with the silica due to weak hydrogen bonding. This creates too much of a dependence of the coupler reacting with the polymer and the silica affinity for ether dominating the reaction. The commercially available couplers including but not limited to Si-69, Si 263, and Si-264 from DeGussa. For example, the 2-hydroxypropyl methacrylate and hyroxyethylacrylate currently known in the prior art contains hydroxy bonds capable to form hydrogen bonding with silica filler. This forms a weak hydrogen bond with the silica filler isolated acid hydroxy group. The hyroxyethylacrylate copolymer does not require any new coagulation system in the ESBR polymerization scheme. In addition, the polar group acts as a hydrophobating agent similar to the addition of poly-ethylene glycol to the surface of the silica filler. Thus there is no chemical bonding between the ESBR containing the hydroxyethylacrylate and the filler. Such a copolymer has no filler interaction chemically.

Un-functionalized ESBR compounds have proven to have very high rolling resistance and poor filler interaction due to the polar characteristics of the fillers such as silica. Moreover ESBR compounds are typically known for their broad molecular weight (Mw/Mn) ratio of greater than 3 to 5, making them less suitable in tire tread applications where improved rolling resistance is needed. Typically when one compounds with current ESBRs to improve these properties, the results involve a compromise of treadwear, traction and rolling resistance.

What is needed in the art is the presence of an ester group which bonds better with the surface of the silica so that the presence of a hydroxy group is not needed. For example a butyl-acrylate ESBR would contain an ester group that forms a chemical bond between the rubber and the isolated hydroxyl group of the silica filler via an ester reaction with the acidic —OH on the silica filler which results in the elimination of ethyl alcohol. This would form a true chemical bond. However, that does not exclude that the ester group of the butyl acrylate would form hydrogen bonds with the jiminal or visceral group of the ester. The formation of this chemical bond results in a deagglomeration of the silica filler. Such a coagulation of the ESBR/BA copolymers may include a technique for preserving the ester group.

Therefore, a compound containing a functionalized emulsion styrene butadiene (ESBR) rubber which interacts well with silica is therefore desirable to the tire and polymer industry. As such, a rubber compound could be created which would improve the rolling resistance while maintaining the traction and wear of the ESBR versus known ESBR and SSBR based compounds.

### BRIEF DESCRIPTION OF THE DRAWINGS

FIG. 1 is a graph of the Mooney Viscosity Curves for the 4 samples, a control compound with 0% functionalization, and experimental compounds with 5% functionalization, 10% functionalization and 15% functionalization.

FIG. 2 is a graph of the ODR Cure Rheometer Curves for the 4 samples.

FIG. 3 is a graph of the Tensile Stress Strain Properties for the 4 samples.

FIG. 4 is a graph of the Tensile Stress Strain Properties (Low strain Region) for the 4 samples.

FIG. 5 is a graph of the Storage Modulus as a Function of Temperature (tension) for the 4 samples.

FIG. 6 is a graph of the Tangent Delta as a Function of Temperature (tension) for the 4 samples.

FIG. 7 is a graph of the Tangent Delta as a Function of Strain (shear) for the 4 samples.

FIG. 8 is a graph of the Storage Modulus as a Function of Strain (shear) for the 4 samples.

FIG. 9 is a graph of the Loss Compliance as a Function of Strain (shear) for the 4 samples.

FIG. 10 is a bar chart comparison of the Storage Modulus at −20° C. for the 4 samples.

FIG. 11 is a bar chart comparison of the Tangent Delta at −10° C. for the 4 samples.

FIG. 12 is a bar chart comparison of the Tangent Delta at 0° C. for the 4 samples.

FIG. 13 is a bar chart comparison of the Tangent Delta at 30° C. for the 4 samples.

FIG. 14 is a bar chart comparison of the Storage Modulus at 30° C. for the 4 samples.

FIG. 15 is a bar chart comparison of the Loss Compliance at 30° C. for the 4 samples.

FIG. 16 is a graph of the Aged Tensile Stress Strain Properties for the 4 samples.

FIG. 17 is a graph of the Aged Tensile Stress Strain Properties (low strain region) for the 4 samples.

FIG. 18 is a comparison plot of the Tire Performance Predictors for the 4 samples.

FIG. 19 is an optical image of a cross section of the control (0% functionalization).

FIG. 20 is a tapping mode height and phase image of the control (0% functionalization).

FIG. 21 is a tapping mode height and phase images of the control (0% functionalization).

FIG. 22 is a tapping mode height and phase images of the control (0% functionalization).

FIG. 23 is a tapping mode height and phase images of the control (0% functionalization)

FIG. 24 is a tapping mode height and phase images of control (0% functionalization).

FIG. 25 is an optical image of a cross-section of sample 2 (5% functionalization).

FIG. 26 is a tapping mode height and phase images of sample 2 (5% functionalization).

FIG. 27 is a tapping mode height and phase images of sample 2 (5% functionalization).

FIG. 28 is a tapping mode height and phase images of sample 2 (5% functionalization).

FIG. 29 is a tapping mode height and phase images of sample 2 (5% functionalization).

FIG. 30 is a tapping mode height and phase image of sample 2 (5% functionalization).

FIG. 31 is an optical image of a cross section of sample 4 (15% functionalization).

FIG. 32 is a tapping mode height and phase images of sample 4 (15% functionalization).

FIG. 33 is a tapping mode height and phase images of sample 4 (15% functionalization).

FIG. 34 is a tapping mode height and phase images of sample 4 (15% functionalization).

FIG. 35 is a tapping mode height and phase images of sample 4 (15% functionalization).

FIG. 36 is a tapping mode height and phase images of sample 4 (15% functionalization).

FIG. 37 is a tapping mode height and phase images of a sample with 20% functionalization of the ESBR.

FIG. 38 is a tapping mode height and phase images of a sample with 20% functionalization of the ESBR.

FIG. 39 is a tapping mode height and phase images of a sample with 25% functionalization of the ESBR.

FIG. 40 is a tapping mode height and phase images of a sample with 25% functionalization of the ESBR.

FIG. 41 is a tapping mode height and phase images of a sample with 30% functionalization of the ESBR.

### SUMMARY OF INVENTION

The present invention discloses functionalized emulsion styrene butadiene rubbers (FE-SBR) with the functional group of the FE-SBR utilizing a broad range of esters or acrylates. In one embodiment the invention discloses a rubber composition, based upon parts by weight per 100 parts by weight of elastomer (phr), comprising: (A) an elastomer comprised of (1) 60 to 90 PHR of a copolymer rubber that is the reaction product of: (a) 10 to 99 weight percent of a conjugated diene monomer which contains from 4 to 8 carbon atoms; (b) 0 to 70 weight percent of a vinyl substituted aromatic monomer; and (c) 1 to 30 weight percent of the monomer of the following general formula I:

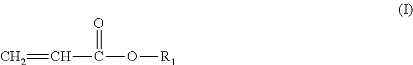

wherein R₁ represents an alkyl group containing from 2 to 12 carbon atoms; and (2) 10 to 40 PHR of at least one conjugated diene-based elastomer; and (B) particulate reinforcement comprised of: (1) 0 to 70 PHR of carbon black; and (2) 20 to 100 PHR of silica; and (C) 1 to 10 PHR of silane based coupling agent.

### DETAILED DESCRIPTION

The following terms are defined herein.

Parts per hundred rubber (phr) is a term used by rubber chemists to define parts of any non elastomer material per hundred parts of elastomer. This is preferred versus an expression of the raw ingredient as a percentage of the total compound weight.

Tg refers to liquid-glass transition or glass transition and is the reversible transition in amorphous materials from the broad and relatively frozen state into a molten or rubber-like state. In polymers the glass transition temperature, Tg, is often expressed as the temperature at which the Gibbs free energy is such that the activation energy for the cooperative movement of 50 or so elements of the polymer is exceeded. This allows molecular chains to slide past each other when a force is applied. From this, one sees that the introduction of relatively stiff chemical groups (such as benzene rings) will interfere with the flowing process and hence increase Tg.

The tread of a tire refers to the patterns on its rubber circumference that makes contact with the road.

The terms “rubber” and “elastomer” can be used interchangeably. In addition the terms “rubber composition”, “compounded rubber” and “rubber compound” are used interchangeably to refer to rubber which has been blended or mixed with various ingredients and materials. Such terms are well known by those in the art or having skill in the art of rubber mixing and rubber compounding.

FE-SBR or functionalized emulsion styrene butadiene rubbers refers to a emulsion polymerized styrene-butadiene rubber with a functional group.

MW is weight average molecular weight which is another way of describing the molecular weight of a polymer.

ML4@100 C involves Mooney Viscosity after 4 min at 100° C. Mooney Viscosity is defined as the shearing torque resisting rotation of a cylindrical metal disk (or rotor) embedded in rubber within a cylindrical cavity. ML typically referring to minimum torque as expressed in N-M or lbf.in. The dimensions of the shearing disk viscometer, test temperatures, and procedures for determining Mooney viscosity is further defined by ASTM 1646 and. Cure Rheometer (ODR) involves an oscillating disc rheometer performed according to ASTM 2084. Tensile properties involving measurements according to ASTM 412-98a using ASTM type die C dumbbell specimens.

Dynamic Mechanical Analysis (temperature sweep in tension) involving a Metravib DMA150 Dynamic Mechanical Analyzer used for temperature sweeps in tension. Experimental conditions being 1° C./min heating rate from −120° C. to 70° C. at 2 Hz with 0.002 dynamic strain and about 0.5 Newton static force. Dynamic Mechanical Analysis (temperature sweep in shear) involving a Metravib DMA150 Dynamic Mechanical Analyzer used for temperature sweeps in shear. Experimental conditions being 2.5° C./min heating rate with 5 minute hold at 0° C., −10° C. and −20° C. at 10 Hz with 5% dynamic strain. Dynamic Mechanical Analysis (strain sweeps) involving a Metravib DMA150 Dynamic Mechanical Analyzer used in shear deformation to perform a double strain sweep experiment (simple shear 10 mm×2 mm geometry) (called dual lap shear geometry). Experimental conditions being 0.001 to 0.5 dynamic strain at 13 points in evenly spaced log steps at 30° C. and 10 Hz.

Representative examples of conjugated diene monomers which may be used include 1,3-butadiene, isoprene, 1,3-ethylbutadiene, 1,3-pentadiene, 1,3,-hexadiene, 1,3 cyclooctadiene, 1,3 octadiene and mixtures thereof. In one embodiment, 1,3 butadiene is used. The copolymer will contain repeat units derived from 10 to 100 weight percent of the conjugated diene. Alternatively the copolymer will contain repeat units derived from 15 to 80 weight percent of the conjugated diene. Preferably, from 20 to 50 weight percent of the copolymer will be derived from the conjugated diene.

The copolymer rubber may also be derived from a vinyl substituted aromatic monomer. The vinyl substituted aromatic compound may contain from 8 to 16 carbon atoms. Representative examples of vinyl substituted aromatic monomers are styrene, alpha methyl styrene, vinyl toluene, 3-methyl styrene, 4-methyl styrene, 4-cyclohexylstyrene, 4-para-tolylstyrene, para-chlorostyrene, 4-tert-butyl styrene, 1-vinylnapthalene, 2-vinylnapthalene and mixtures thereof. In one embodiment styrene is used. The copolymer will contain repeat units derived from 0 to 70 weight percent of the vinyl substituted aromatic monomer. Alternatively from 4 to 10 weight percent of the copolymer is derived from a vinyl substituted aromatic monomer. Preferably from 20 to 40 weight percent of the copolymer is derived from a vinyl substituted aromatic monomer.

The copolymer rubber is also derived from a monomer of the following formula:

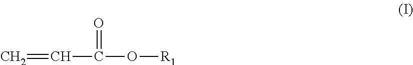

Where the R₁ represents an alkyl group containing from 2 to 12 carbon atoms. Alternatively the R₁ represents an alkyl group containing from 2 to 8 carbon atoms. Finally, the R₁ represents an alkyl group containing from 4 to 6 carbon atoms. Several examples of the copolymer of Formula I are a C2 acrylate, a C3 acrylate, propyl acrylate, a C4 acrylate, butyl acrylate, a C5 acrylate, penta-acrylate, a C6 acrylate, hexa-acrylate, a C7 acrylate, hepta-acrylate, a C8 acrylate, octa-acrylate, a C9 acrylate, a C10 acrylate, a C11 acrylate, or a C12 acrylate.

In one embodiment the copolymer rubber has a repeating unit of monomer from Formula (I). In another embodiment, the copolymer will contain repeat units derived from 1 to 30 weight percent of monomer from Formula (I). In yet another embodiment, the copolymer will contain repeat units derived from 5 to 15 weight percent of monomer from Formula (I).

In one embodiment the Tg of the copolymer rubber ranging from −10° C. to −70° C. In another embodiment the Tg of the copolymer rubber ranging from −25° C. to −65° C. In yet another embodiment the Mooney viscosity of the copolymer rubber ranges from 20 to 120 (ML4@100 C). In still yet another embodiment the Mooney viscosity of the copolymer rubber ranges from 25 to 85 (ML4@100 C).

The copolymer rubber ranges from 60 to 90 PHR of the total rubber used. In one embodiment, the copolymer rubber ranges from 70 to 80 PHR of the total rubber used.

The elastomer of the present invention can be synthesized, for example, by using conventional elastomer polymerization methods. In one embodiment a charge composition may be comprised of water, one or more conjugated diolefin monomers (e.g., 1,3 butadiene), one or more vinyl aromatic monomers (e.g., styrene) and an alkyl acrylate (e.g. butyl acrylate), a suitable polymerization initiator and emulsifier (soap) The polymerization may be conducted over a relatively wide temperature range such as for example, from about 5° C. to 50° C. In another embodiment a temperature range of 5° C. to 25° C. In one embodiment the emulsifiers may be added at the onset of the polymerization or may be added incrementally, or proportionally as the reaction proceeds. The emulsifiers may be anionic, cationic or nonionic. Latexes can be coagulated using acids (e.g. sulfuric acid). Acids with a pKa lower than 4 can be used, but caution must be taken due to the strong acidic media that can hydrolyze the ester group (e.g. the way of its dosage). In one alternative ammonia salts may be used.

In addition to the copolymer rubber, the rubber composition contains at least one conjugated diene-based elastomer. The additional rubber ranges from 10 to 40 PHR of the total rubber used. In one embodiment, the additional rubber ranges from 20 to 30 PHR of the total rubber used. Representative examples of various additional conjugated diene-based elastomers for use in this invention include, by way of example, cis 1,4-polyisoprene rubber (natural or synthetic), c is 1,4,-polybutadiene, nickel catalyzed polybutadiene, transition metal polybutadiene, high vinyl polybutadiene having a vinyl 1,2 content in a range of about 10 percent to about 90 percent, 1,3 butadiene, isoprene, styrene/butadiene copolymers (SBR) including emulsion polymerization prepared SBR and organic solvent polymerization SBR, styrene/isoprene/butadiene copolymers, isoprene/butadiene copolymers and isoprene/styrene copolymers. In another embodiment the conjugated diene-based elastomer being commercially known as Synthium 44 or Synteca 44.

The rubber composition may also include up to 120 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Representative process oils include oils known in the art including aromatic, paraffinic, napthenic, vegetable oils, and low PCA oils, such as MES, TDAE, SRAE, RAE and heavy napthenic oils. Suitable low PCA oils include those having a polycyclic aromatic content of less than 3 percent by weight as determined by the IP346 method. Procedures for IP346 are known in the art and can be found in the standards published by the Institute of Petroleum, United Kingdom. In another embodiment the processing oil known commercially as Sundex 790.

The rubber composition may include from about 20 PHR to about 120 PHR of silica. In yet another embodiment the rubber composition may include from about 45 PHR to about 80 PHR of silica are used. In still yet another embodiment the rubber composition may include from about 60 PHR to 70 PHR of silica are used. Examples of siliceous pigments which may be used in the rubber composition include conventional pyrogenic and precipitated siliceous pigments (silica). In one embodiment precipitated silica is used. In another embodiment the rubber composition has a chemical reaction where the result is a reaction of the elastomer directly with silica.

The conventional siliceous pigments employed in this invention are precipitated silicas such as, those obtained by the acidification of a soluble silicate e.g., sodium silicate. Conventional silicas may be characterized by having a BET surface area as measured using nitrogen gas. In one embodiment the BET surface area may be in the range of about 40 to about 600 square meters per gram. In another embodiment the BET surface area may be in the range of about 80 to about 300 square meters per gram. The BET surface area method is known in the art and can also be found in the Journal of the American Chemical Society, Volume 60, Page 304 (1930).

The conventional silica may also be characterized by having a dibutylphthalate (DBP) absorption value in a range of about 100 to about 400 or alternatively from about 150 to 300.

The conventional silica might be expected to have an average ultimate particle size in the range of 0.01 to 0.05 micron as determined by the electron microscope, although the silica particle may even be smaller, or possibly larger in size.

Various commercially available silicas may be used, such as, but not limited to, silica commercially available from PPG Industries under the Hi-Sil trademark with designations 170, 210, 243, etc.; silicas available from Rhodia, with, for example, designations of Z1165MP and Z165GR, silicas available from DeGussa AG with, for example, designations VN2 and VN3, etc.; Si-69, Si 263, and Si-264 from DeGussa; and commercially available silicas under the Ultrasil 7000 GR brand name.

Commonly employed carbon blacks as known in the art can be used as a conventional filler in an amount ranging from 0 to 70 PHR. In another embodiment from 12 to 25 PHR of carbon black may be used. Representative examples of carbon blacks include but are not limited to: N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. IN another embodiment the carbon blacks having iodine absorptions ranging from 9 to 145 g.kg and DBP number ranging from 34 to 150 cm³/100 g.

Other fillers may be used in the rubber composition including, but not limited to, particulate fillers including ultra high molecular weight polyethylene, cross linked particulate polymer gels, and plasticized starch composite filler. Such fillers may be used in an amount ranging from 1 to 30 phr.

In one embodiment the rubber composition may contain a conventional sulfur containing organosilicon compound. Examples of suitable sulfur containing organosilicon compounds are of formula:

Z-Alk-Sₙ-Alk-Z (II)

In which Z is selected from the group consisting of:

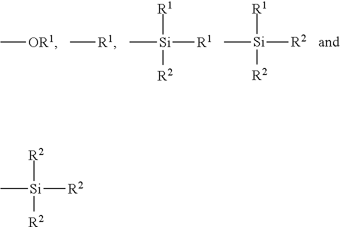

Where R¹ is an alkyl group of 1 to 4 carbon atoms, cyclohexyl or phenyl; R² is an alkoxy of 1 to 8 carbon atoms, or cycloalkoxy of 5 to 8 carbon atoms; Alk is a divalent hydrocarbon of 1 to 18 carbon atoms and n is an integer of 2 to 8.

In one embodiment, the sulfur containing organosilicon compounds are the 3,3′-bis(trimethoxy or triethoxy silypropyl)polysulfides. In one embodiment, the sulfur containing organosilicon compounds are 3,3′-bis(triethoxysilypropyl)disulfide and/or 3,3′-bis(triethoxysilylpropyl)tetrasulfide. Thereby formula (II) Z may be:

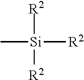

where R² is an alkoxy of 2 to 4 carbon atoms, alternatively 2 carbon atoms, alk is a divalents hydrocarbon of 2 to 4 carbon atoms, alternatively with 3 carbon atoms and n is an integer of from 2 to 5, alternatively 2 or 4.

In one embodiment the sulfur containing organosilicon is commercially known in the art as Si-69. In another embodiment the sulfur containing organosilicon is commercially known in the art as Si-363. In another embodiment the sulfur containing organosilicon is commonly known as a silane coupling agent or silane coupler. In another embodiment the sulfur containing organosilicon is commercially known in the art as Si-263 or Si-262. In another embodiment the sulfur containing organosilicon is any other similar and commercially available silica coupler to those listed above.

The amount of the sulfur containing organosilicon compound in a rubber composition will vary depending on the level of other additives that are used. Generally speaking the amount of the compound will range from 1 to 10 phr. Alternatively from 3 to 7.5 phr.

In one embodiment, the rubber composition having a chemical reaction where the end product involves polymer-filler reactions which are at a ratio of 3 to 1 for chemical reactions with the silica via the ester group versus the silane or organosilicon based coupling agent. The presence of the chemical reaction between the elastomer and silica as reported in Gelest Inc. references on silica and silane coupling agents available at www.gelest.com.

It is readily understood by those with skill in the art that the rubber composition would be compounded by methods generally known in the rubber compounding art, such as mixing the various sulfur-vulcanized constituent rubbers with various commonly used additive materials such as, for example, sulfur donors, curing aids, such as activators and retarders and processing additives, such as oils, resins including tackifier resins and plasticizers, fillers, pigments, fatty acid, zinc oxide, waxes, antioxidants and antiozonants and peptizing agents. As known to those skilled in the art, depending on the intended use of the sulfur vulcanizable and sulfur vulcanized material (rubbers), the additives mentioned above are selected and commonly used in conventional amounts. Representative examples of sulfur donors include elemental sulfur (free sulfur), an amide disulfide, polymeric polysulfide and sulfur olefin adducts. In one embodiment the sulfur vulcanizing agent is elemental sulfur. The sulfur vulcanizing agent may be used in amounts from 0.4 to 7 phr, alternatively with a range of 1.1 to 2.3 phr. Typical amounts of tackifier resins, if used, comprise about 0.5 to about 10 phr. Typical amount of processing aids comprise about 1 to about 50 phr. Typical amounts of antioxidants comprise about 1 to about 5 phr. Representative antioxidants may be diphenyl-p-phenylenediamine and others which can by example be found in the Vanderbilt Rubber Handbook (pp 443-450). Typical amounts of antiozonants comprise about 1 to about 5 phr. Typical amounts of fatty acids if used which can include stearic acid comprise about 0.5 to 3 phr. Typical amounts of zinc oxide comprise about 2 to about 5 phr. Typical amount of waxes comprise about 1 to about 5 phr. Typical amount of peptizers comprise about 0.1 to about 1.0 phr. Typical waxes being microcrystalline waxes and typical peptizers being pentachlorothiophenol and dibenzamidodiphenyl disulfide.

In the mixing arts, accelerators are typically used to control the time and/or temperature required for vulcanization and to improve the properties of the vulcanizate. In one embodiment, a single accelerator system may be used, i.e., the primary accelerator. The primary accelerator may be used in total amounts from about 0.5 to 4.0 phr, alternatively from 1 to 1.75 phr. In another embodiment, combinations of a primary and a secondary accelerator might be used with the secondary accelerator being used in smaller amounts, such as from 0.05 to 3.0 phr. Combinations of these accelerators might be expected to produce a synergistic effect on the final properties and are somewhat better than those produced by use of either accelerator alone. In addition vulcanization retarders may be used. Suitable types of accelerators that may be used in the present invention are amines, disulfides, guanidines, thioureas, thiazoles, thiurams, sulfenamides, dithiocarbamates and xanthates. In one embodiment the primary accelerator is commercially known as Santocure CBS and the secondary accelerator is commercially known as DPG.

The mixing of the rubber composition can be accomplished by methods known to those having skill in the rubber mixing art. For example the ingredients are typically mixed in at least two stages, namely, at least one non-productive stage followed by a productive stage mix. In additional embodiments three, four, five and six stage mixes are possible. Alternatively the mix being a three stage mix consisting of two non-productive stages followed by a productive stage mix. The final curatives including sulfur-vulcanizing agents are typically mixed in the final stage which, as noted above, is called the productive stage. This productive stage typically occurring at temperatures lower than the previous non-productive stages. The term non-productive and productive are well known to those in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example the thermomechanical working may be from 1 to 20 minutes. Alternatively the non-productive steps utilize a lower rotor mixing speed early in the stage followed by an increased speed later in the stage with this procedure being commonly used to aid in the dispersion and mixing of the silica.

The rubber composition may be incorporated in a variety of rubber components of the tire. For example, the rubber component may be a tread (including cap/base/wing) sidewall, apex, chafer, sidewall insert, wire coat or innerliner. In one embodiment the rubber composition is used as a tread. This tread could be used on a race tire, passenger car tire, truck tire, aircraft tire, off the road tire, agriculture tire, earthmover tire, or off the road tire. This tread could be used on a bias or radial tire.

Vulcanization of the tire is generally carried out at conventional temperatures from about 100° C. and 200° C. Any of a number of vulcanizational methods may be used such as heating in a press or mold, or heating with super heated steam or hot air. Such tires can me built, shaped, molded and cured by various methods which are known by those skilled in the art.

In one embodiment the rubber composition having a weight average molecular weight between 200,000 and 800,000 g/mol. In yet another embodiment the rubber composition having a weight average molecular weight between 220,000 and 500,000 g/mol. Finally in one embodiment the rubber composition of claim having a weight average molecular weight between 250,000 and 410,000 g/mol.

In one embodiment the rubber composition having a ratio of total phr of silica to carbon black of 1 to 1. In yet another embodiment the rubber composition having a ratio of total phr of silica to carbon black of 2 to 1. In still another embodiment the rubber composition having a ratio of total phr of silica to carbon black of 3 to 1.

The prior art describes improvements in rolling resistance to a lesser extent, however the present invention details a 20-30% improvement in rolling resistance without sacrificing traction and wear. The use of FE-SBR being superior to the prior art and the use of ESBR alone. In addition the FE-SBR being superior to the use of SSBR, as FE-SBR has significantly improved treadwear over SSBR.

FE-SBR functionalized polymer provides superior properties that make the present invention useful for rubber compound and specifically tire tread applications. This is due to that fact even though the FE-SBR has an undesirable Mw/Mn distribution, similar to un-fictionalized ESBR, it was unique in its filler polymer interaction via the esterification reaction with the silanol group. As such, only small amounts of the functional monomers are needed for this reaction thus explaining why one preferred concentration of butyl acrylate monomer is between 5% to 10%. The data presented confirms the same as does the Atomic Force Microscopy detailed herein.

One mechanism explaining the butyl acrylate functionalized FE-SBR as the ester groups reacting with and isolating the Si—OH group of the acidic hydroxyl silanol group in this manner:

(CH2-CH2-CO—OR)n+Si—OH—(CH2-CH2-CO—OSi)m+ROH (III)

The invention is further illustrated by the following non-limiting examples.

### EXAMPLES

In this example, the effects of using a functionalized emulsion styrene butadiene rubber (FE-SBR) with the functional group of the FE-SBR utilizing an ester or acrylates is illustrated. The FE-SBR represented in this example is the copolymer rubber of the present invention. Two rubber compounds were compared to show the results of using the ester/acrylate of different levels. In this example a butyl acrylate polymer being used as the functional monomer. A control lacking the functional monomer is included to demonstrate improvements in ultimate rubber (and tire) properties seen.

The rubber compositions were prepared in an internal rubber mixer, using three separate stages of addition (mixing), i.e. 2 non-productive stages and one productive stage. The first non productive stage was mixed to 160° C. The second non productive stage was mixed to 140-145° C. The productive stage was mixed to 110° C. Both non-productive steps utilizing a lower rotor mixing speed early in the stage followed by an increased speed later in the stage.

For the polymerization of standard ESBR, and for background of polymerization of ESBR in general, Table 1 details the raw materials required, including monomers (styrene and butadiene), emulsifier, water, initiator system, shortstop, modifier, and a stabilizer system. Current commercial productions of ESBR are run continuously by feeding reactants and polymerizing through a chain of reactors before shortstopping at the desired monomers conversion(s). The monomers being continuously metered into the reactor chains and emulsified with emulsifiers and catalyst agents. In one embodiment of cold polymerization, the initiator system is the redox reaction between chelated iron and organic peroxide using sodium formaldehyde sulfoxide (SFS) as a reducing agent (see IV and V below). In another embodiment of hot polymerization, potassium peroxydisulfate is used as an initiator.

Fe(II) EDTA+ROOH→Fe(III) EDTA+RO.+OH. (IV)

Fe(III) EDTA+SFS→Fe(II) EDTA (V)

At this stage, mercaptan is added to furnish free radicals and to control the molecular weight distribution by terminating existing growing chains and initiating a new chain. The thiol group acting as a chain transfer agent to prevent the molecular weight from attaining excessively high values which are possible in emulsion systems. The sulfur-hydrogen bond in the thiol group being susceptible to attack by the growing polymer radical and thus losing a hydrogen atom when reacting with polymer radicals. This is shown in equation (VI). The RS. formed continues to initiate the growth of a new chain as shown in equation (VII) below. The thiol also preventing gel formation and improving the processability of the rubber.

P.+RSH→P—H+RS. (VI)

RS.+M→RS-M. (VII)

TABLE 1

Parts by Weight

| Component | Cold | Hot |
|---|---|---|
| Styrene | 25 | 25 |
| Butadiene | 75 | 75 |
| Water | 180 | 180 |
| Emulsifier (FA, RA, MA) | 5 | 5 |
| Dodecyl mercaptan | 0.2 | 0.8 |
| Cumene hydroperoxide | 0.2 | — |
| FeSO4 | 0.02 | — |
| EDTA | 0.06 | — |
| Na4P2O7•10H2O | | 1.5 |
| Potassuim persulfate | | 0.3 |
| SFS | | 0.1 |

During polymerization, parameters such as temperature, flow rate and agitation are controlled to obtain the proper conversion. Polymerization is normally allowed to proceed to about 60% conversion in cold polymerization and 70% in hot polymerization before it is stopped with a shortstop agent that reacts rapidly with the free radicals. Some common shortstopping agents being sodium dimethyldithiocarbamate and diethyl hydroxylamine.

Once the latex is shortstopped, the unreacted monomers are stripped off the latex. Butadiene is stripped by degassing the latex by flash distillation and reduction of system pressure. Styrene is removed by steam stripping the latex in a column. The latex is then stabilized with the appropriate antioxidant and transferred to blend tanks. In the case of oil-extended polymers and/or carbon black masterbatches, these materials are added as dispersions to the stripped latex. The latex being transferred to finishing lines to be coagulated with sulfuric acid, sulfuric acid/sodium chloride, glue/sulfuric acid, aluminum sulfate, or amine coagulation aid. The type of coagulation system being selected depending on the product. Sulfuric acid/sodium chloride being used for general purpose, glue/sulfuric for electrical grade and low water sensitivity SBR, sulfuric acid for coagulations where low-ash-polymer is required, and amine coagulating aids to improve coagulation efficiency and reduce production plant pollution. The coagulated crumb is later washed, dewatered, dried, baled and packaged.

Regarding the example herein, coagulation of FE-SBR with butyl acrylate (BA) latexes can be accomplished by a variety of means, however in one embodiment, the ESBR functionalized with 10% or 15% (by weight) of butyl acrylate was prepared by cold emulsion polymerization. This polymerization was performed in a 10 liter reactor at 5 to 8° C. The ESBR recipe being based upon commercially available ESBR 1500 grades. In this embodiment the dosages of monomers for polymerization being: styrene 20 to 25 wphm, 1,3-butadiene 60 to 70 wphm and butyl acrylate 10 to 15 wphm. Emulsifier was formed by 80 to 100% of disproportionated rosin soap and 0 to 20% of fatty acids soap with the total dosage of the emulsifier being between about 4 to 6 wphm. For initiation of the polymerization, a redox system was used. The system was comprised of diisopropylbenzene hydroperoxide, ferrous ions chelated by EDTA and formaldehyde sulfoxylate. The electrolytes being predominantly on the base of a chloride. Regulation of molecular weight, and thus Mooney viscosity, was performed using tert-dodecyl mercaptane dosed in amount from 0.17 to 0.22 wphm. In this embodiment, the targeted Mooney viscosity of the rubber was 50 ML (100° C., 1+4). Diethylhydroxylamine was utilized as a short stopper of the polymerization, with the polymerization being carried out in such a way to achieve final conversion of monomers from 65% to 70% in 5 to 8 hours. The glass transition (Tg) of the prepared rubber samples being in the range of about −52° C. to −54° C. The prepared FE-SBR samples containing between 10% and 15%, by weight, of bound butyl acrylate. This amount being confirmed using ¹H-NMR.

In another embodiment, higher levels of functionalization were desired. As such, for FE-SBR with levels of 20% to 25% of butyl acrylate (or other acrylate) this same process can be utilized by changing the 1,3-butadiene dosage from 60-70 wphm to 50-70 wphm (or alternatively 50 to 60 wphm). In addition, for levels of 20% to 25% of butyl acrylate, the process uses less 1,3-butadiene and styrene since a mixture of both monomers is essentially replaced by butyl acrylate (or other acrylate). The ratio styrene-to-butadiene is kept constant. The other preparation parameters remaining virtually the same. In still yet another embodiment, acrylate levels of up to 30% are used with preparation ratios adjusted accordingly.

Coagulation of FE-SBR with butyl acrylate (BA) latexes can be accomplished by a variety of means, however in order that the coagulation of the ESBR/BA copolymers preserves the ester group, care is taken in their preparation. Isolation of rubber from latexes is performed using a synthetic coagulant and organic acid. Prior to the coagulation, a staining antioxidant on the base of 6PPD in the amount of 0.5% per rubber in the form of emulsion was added to the latex. The pH of the coagulation serum is in the range from 3.0 to 6.0 (or alternatively 3.5 to 5.0) and the temperature is between 55° C. and 75° C. After coagulation, the serum with rubber crumbs was neutralized using a hydroxide to pH about 5.5-7.5. The resulting rubber crumbs are drained using a centrifuge, milled and dried in an oven at 70° C. to 90° C. to a residual humidity lower than 0.1%. The resulting FE-SBR with butyl acrylate being prepared, in the following examples, with a non-functionalized control and at a 5% by weight, at a 10% by weight and a 15% by weight level for the functional monomer.

Material used in this example is shown in Table 2. The physical properties of the rubber samples are detailed in Table 3.

TABLE 2

| | Sample No. | | | |
|---|---|---|---|---|
| | 1 | | | |
| | 0% | 2 | 3 | 4 |
| | (control) | 5% | 10% | 15% |
| First Non-Productive Mixing Step | | | | |
| ESBR (0% functionalized monomer) | 75 | | | |
| polymer¹ | | | | |
| FE-SBR (5% functionalized monomer) | | 75 | | |
| polymer¹ | | | | |
| FE-SBR (10% functionalized monomer) | | | 75 | |
| polymer¹ | | | | |
| FE-SBR (15% functionalized monomer) | | | | 75 |
| polymer¹ | | | | |
| PBD rubber² | 25 | 25 | 25 | 25 |
| Carbon Black³ | 18 | 18 | 18 | 18 |
| Silica⁴ | 66 | 66 | 66 | 66 |
| Silane Coupler⁵ | 5.3 | 5.3 | 5.3 | 5.3 |
| Aromatic Oil⁶ | 33 | 33 | 33 | 33 |
| Stearic Acid | 1.5 | 1.5 | 1.5 | 1.5 |
| Second Non-Productive Mixing Step | | | | |
| Zinc Oxide | 1.9 | 1.9 | 1.9 | 1.9 |
| Waxes | 2 | 2 | 2 | 2 |
| 6PPD | 2 | 2 | 2 | 2 |
| Processing Aids | 2 | 2 | 2 | 2 |
| Diphenyl p-phenylene diamine⁷ | 0.5 | 0.5 | 0.5 | 0.5 |
| Productive Mixing Step | | | | |
| Sulfur | 1.6 | 1.6 | 1.6 | 1.6 |
| Accelerators⁸ | 3 | 3 | 3 | 3 |

¹Emulsion E-SBR with 0 to 15% functional butyl acrylate polymer.
²Nd-PBD Rubber
³N234 Carbon Black
⁴Ultrasil 7000GR Silica with 170 surface area
⁵Si 69 Silane Coupling agent
⁶Sundex 790 aromatic oil
⁷Wingstay 100
⁸Santocure CBS and SPG

TABLE 3

| | Sample No. | | | |
|---|---|---|---|---|
| | 1 | | | |
| | 0% | 2 | 3 | 4 |
| | (control) | 5% | 10% | 15% |
| Room Temperature | | | | |
| Tensile (die C.) | | | | |
| Peak stress (psi) | 2961 | 2968 | 3135 | 3166 |
| Peak strain (%) | 523 | 527 | 536 | 547 |
| Modulus at 100% strain | 242 | 257 | 257 | 265 |
| (psi) | | | | |
| Modulus at 300% strain | 1305 | 1349 | 1404 | 1419 |
| (psi) | | | | |
| DMA Strain Sweep | | | | |
| in Shear (30° C. | | | | |
| and 5% strain) | | | | |
| Tan Delta | 0.244 | 0.252 | 0.240 | 0.241 |
| Storage Modulus (Pa) | 1.63E+06 | 1.57E+06 | 1.52E+06 | 1.45E+06 |
| Loss Compliance (1/Pa) | 1.41E−07 | 1.51E+06 | 1.49E−07 | 1.57E−07 |
| DMA Temperature | | | | |
| Sweep in Shear | | | | |
| (5% strain) | | | | |
| Tan Delta at −10° C. | 0.350 | 0.362 | 0.364 | 0.374 |
| Tan Delta at 0° C. | 0.299 | 0.311 | 0.298 | 0.315 |
| Storage Modulus at −20° | 3.28E+06 | 3.02E+06 | 3.29E+06 | 3.00E+06 |
| C. (Pa) | | | | |
| DMA Temperature | | | | |
| Sweep (in tension | | | | |
| @ 0.2% strain) | | | | |
| Tg (loss modulus peak | −47.4 | −45.9 | −42.4 | −39.6 |
| temperature ° C.) | | | | |
| Mooney Viscosity | | | | |
| Initial Viscosity (Mooney | 114 | 106 | 108 | 108 |
| Units) | | | | |
| After 4 min at 100° C. | 67.6 | 63.8 | 66.2 | 65.9 |
| (Mooney Units) | | | | |
| ODR - Cured Rheometer | | | | |
| Delta Torque | 40.7 | 42.2 | 42.3 | 42.6 |
| T90 (min) | 6.07 | 6.04 | 6.04 | 6.37 |

Various tests were run on the control (sample 1) and the FE-SBR samples (samples 2, 3 and 4) to ascertain the final rubber properties. From these tests, standard elastomer, rubber and tire properties can be evaluated. It is widely known in the art, of the correlation between these dynamic and static tests and ultimate rubber/tire properties. A majority of the discussion to follow references the data in Table 3 and the figures as applicable. For purposes of the figures the control is referenced as either control or 0% BA. Samples 2, 3 and 4 detailing the 5%, 10% and 15% levels of functionalized polymer, usually BA (butyl acrylate). Another reference utilized involves ERTNB5-97-1 for the control, ERTNB5-97-2 for the 5%, ERTNB5-97-3 for the 10% and ERTNB5-97-4 for the 15%.

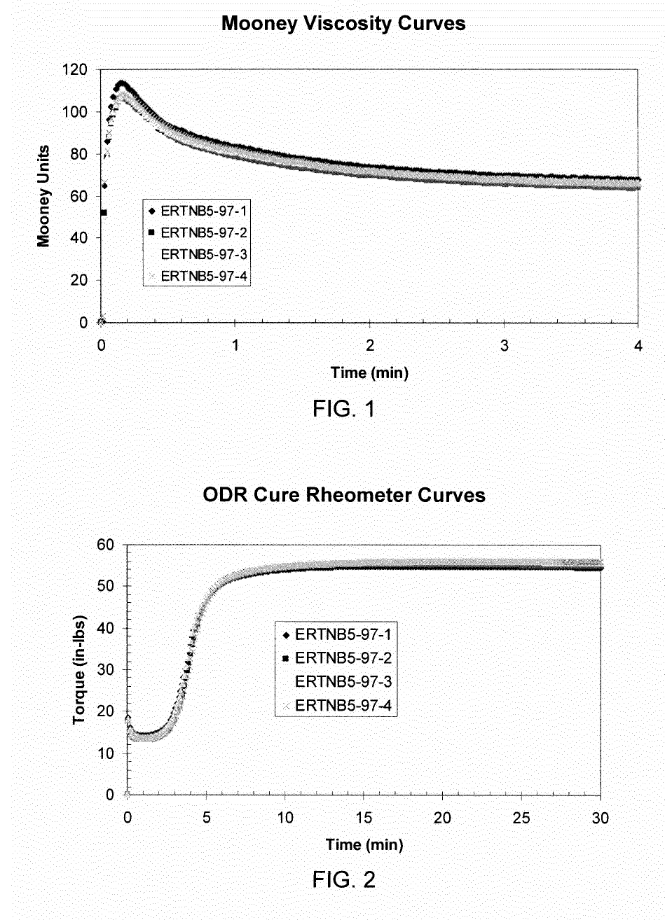

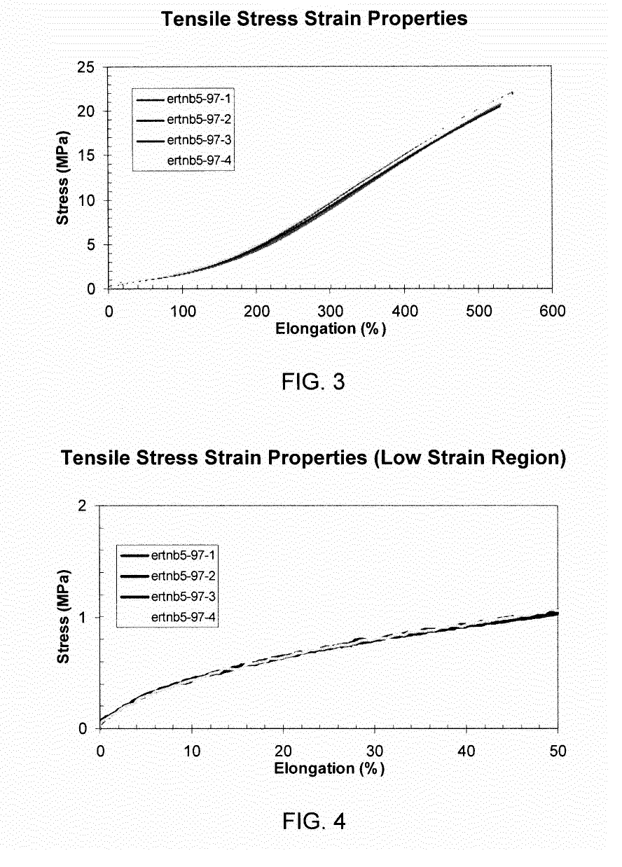

The FE-SBR (samples 2, 3 and 4) possessed slightly lower Mooney Viscosities than the control compound (sample 1). This trend is further detailed in FIG. 1 where the Mooney viscosity curves are lower for the FE-SBR samples versus the control. FIG. 2 provides a graph of the higher delta torque values for the FE-SBR samples versus the control. The FE-SBR samples having a higher delta torque in the ODR testing than the control is an indicator of improved polymer/filler interaction. Also indicative of improved polymer/filler interaction for the FE-SBR samples are the stress at break and elongation at break (peak strain) in the tensile testing as being higher than the control. This trend is further detailed in FIGS. 3 and 4.

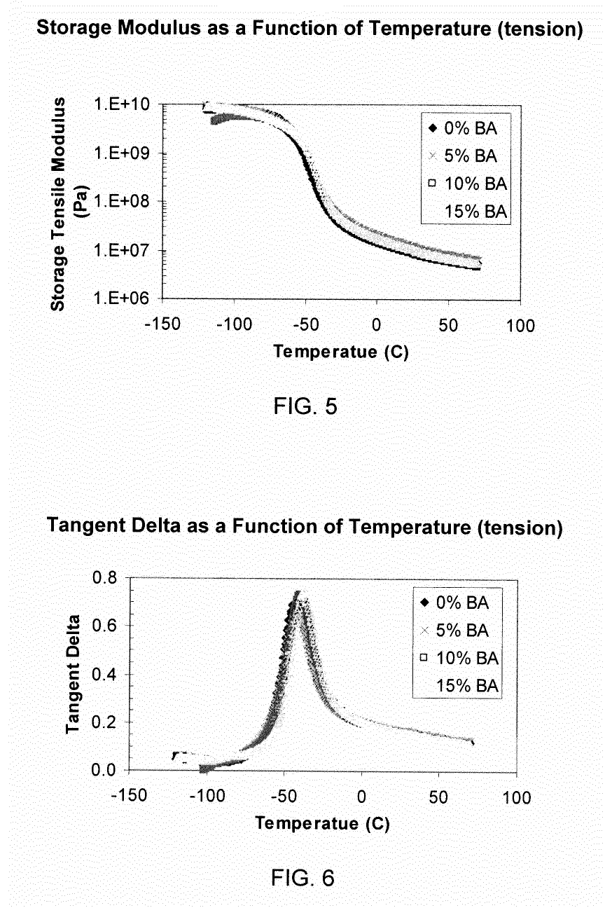

DMA Temperature Sweep (in tension @ 0.2% strain) testing details the Tg of the FE-SBR as increasing with additional butyl acrylate versus the control. This trend is further detailed in FIGS. 5 and 6. FIG. 5 being a graph of Storage Tensile Modulus versus temperature. FIG. 5 showing an increase in Tg as levels of functionalization (BA) were increased. FIG. 6 showing Tangent Delta versus temperature for the control and samples 2, 3 and 4. One notes a small tangent delta peak around −85° C. which is indicative of phase separation for the 15% level (sample 4).

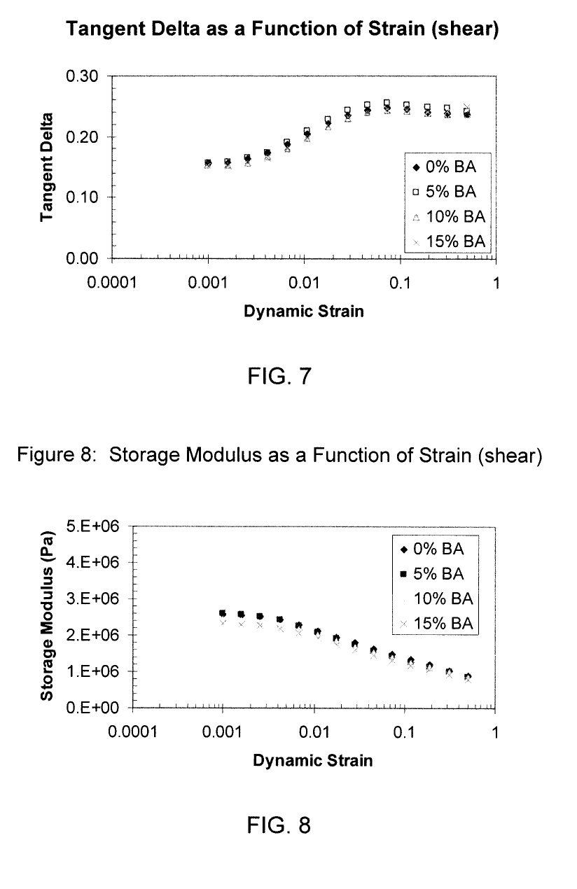

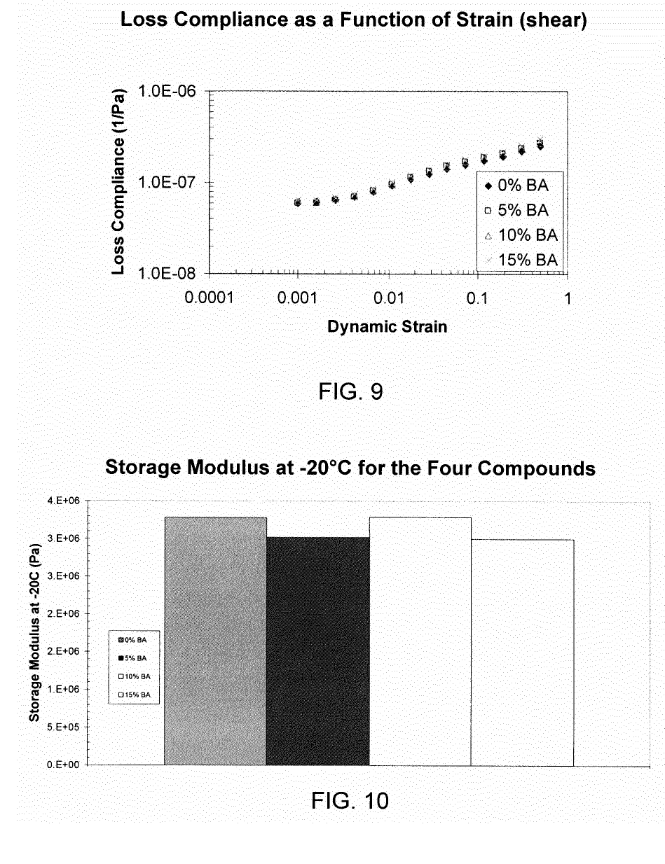

DMA Temperature Sweep (in shear @ 5% strain) testing shows the FE-SBR samples (2, 3 and 4) having improved results in areas indicative of tire properties. The properties were measured at 0° C., −10° C., and −20° C., in shear at 5% strain. FIG. 7 provides a comparison of tangent delta as a function of shear, FIG. 8 detailing storage modulus as a function of strain, and FIG. 9 shows loss compliance as a function of strain (shear).

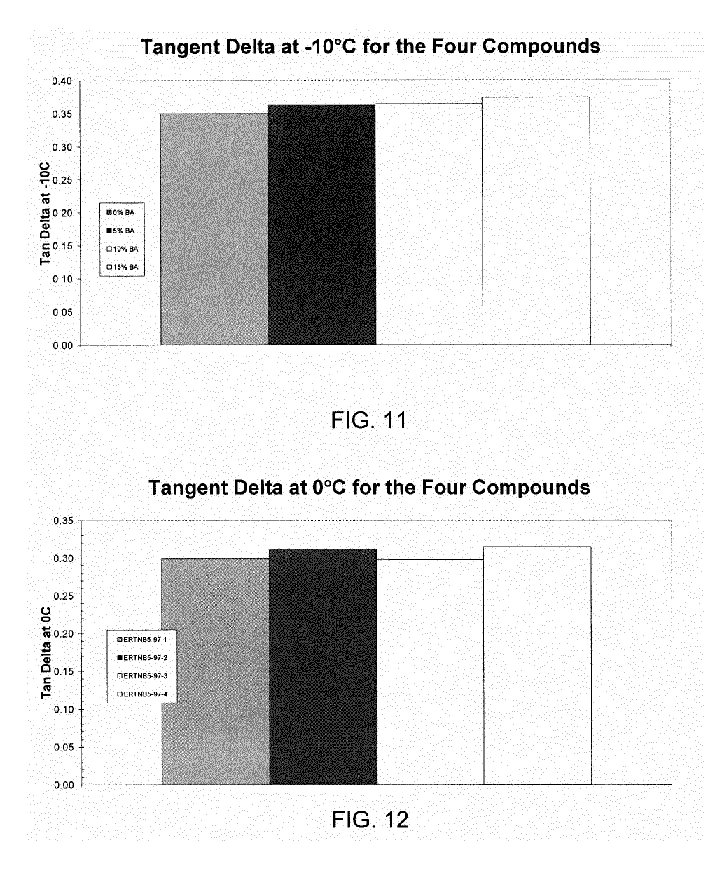

These known DMA Temperature Sweep (in shear @ 5% strain) indicators of tire performance include: Storage Modulus at −20° C., an indicator of winter traction, with the lower values of the FE-SBR samples being better than the control (see FIG. 10); Tan Delta at −10° C., an indicator of ice traction, with the higher values of the FE-SBR samples being improved versus the control (see FIG. 11); and Tan Delta at 0° C., an indicator of wet traction, with the higher values of the FE-SBR samples here being better versus the control (see FIG. 12).

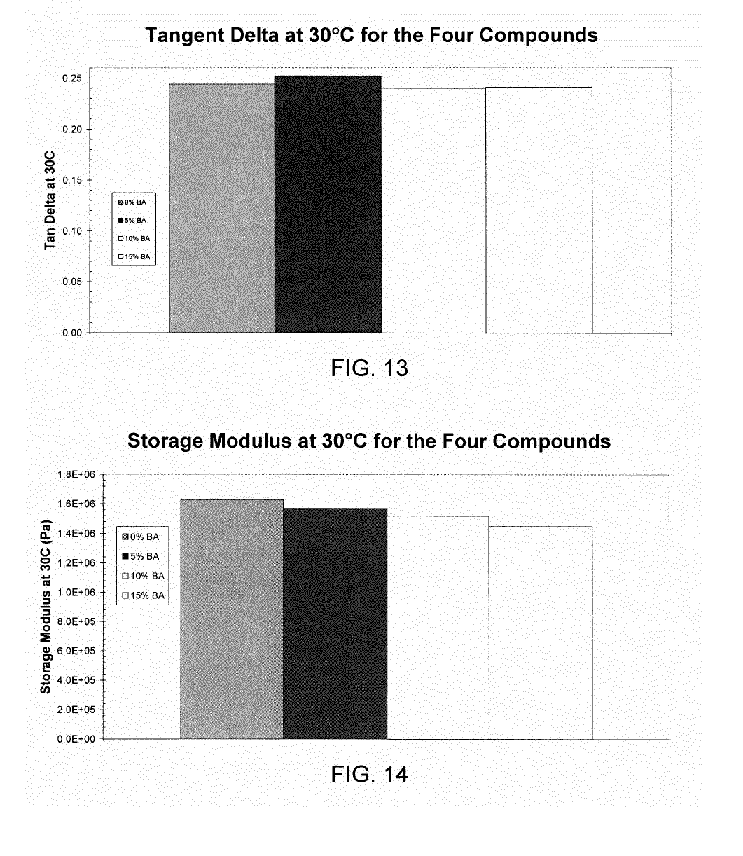

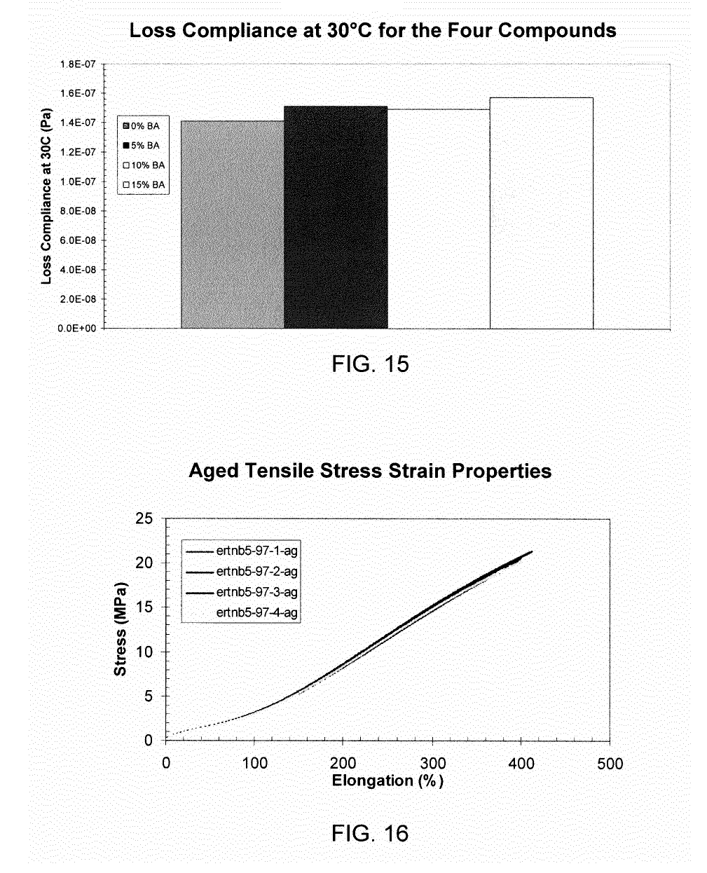

DMA Strain Sweep (30° C.) also provides improved results with the FE-SBR samples improving in areas indicative of tire properties. Known DMA Strain Sweep (30° C.) indicators of tire performance include: Tan Delta at 5% strain, an indicator of dry handling, with the slightly lower values of the FE-SBR samples being down, but on par with the control (see FIG. 13) lower values indicating better rolling resistance; Storage Modulus at 5% strain, an indicator of dry handling, with the lower values of the FE-SBR samples showing equal to slightly worse results than the control (see FIG. 14) higher values indicating better dry handling; and Loss Compliance at 5% strain, an indicator of dry traction, with the higher values of the FE-SBR samples better than the control (see FIG. 15) higher values indicating better dry traction. The overall indicators of this test detailing improved how the functionalized polymer showing improvements in dry traction, equal performance in fuel economy and a slight drop in dry handling.

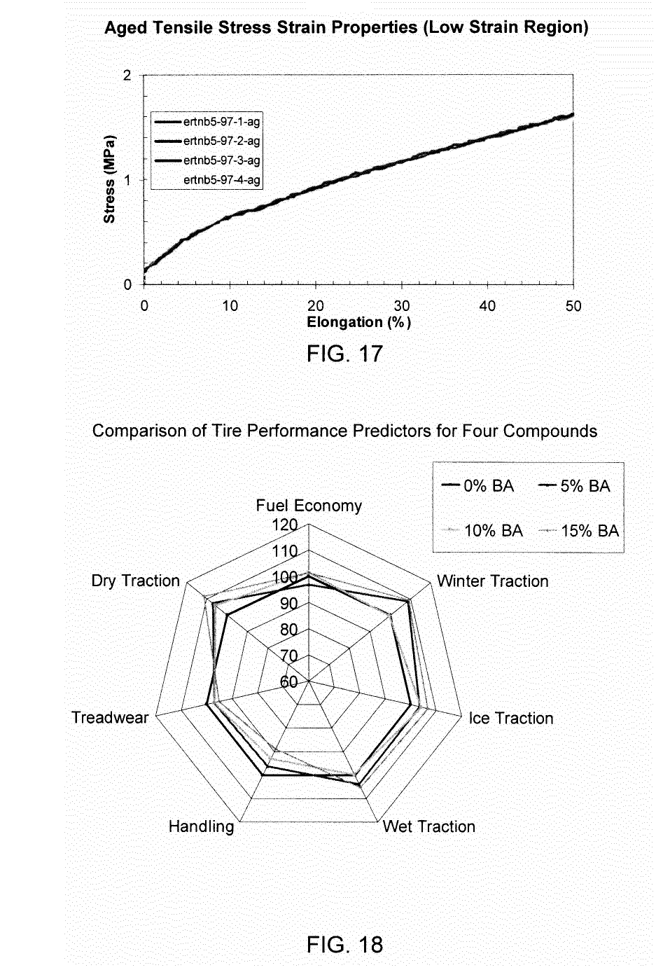

Additional testing was performed on aged tensile properties. The added tensile stress strain properties were measured in FIGS. 16 and 17. There the experimental compounds stress strain properties were similar to the control with a slight property loss versus the control.

Treadwear was estimated using the ARDL treadwear prediction method (Martens, Terrill and Lewis, Paper No. 71 “Effect of F-S-SBR in Silica Tire Tread Formulation” presented at the Fall 180^{th} Technical Meeting of the Rubber Division American Chemical Society, 2011). This process predicts treadwear based on tensile strength (higher being better), energy to break (higher being better), aging resistance (higher is better) and compound glass transition temperature (lower is better). The treadwear predictions of the experimental compounds were slightly lower than the control. The results are shown in Table 4:

TABLE 4

Sample No.

| ARDL | 1 | | | |
|---|---|---|---|---|
| TREADWEAR | 0% | 2 | 3 | 4 |
| PREDICTION | (control) | 5% | 10% | 15% |
| TW Rank | 100 | 97 | 97 | 95 |

A comparison plot of all the tire predictors is shown in FIG. 18. The predictors were normalized to 100 based on the 0% functionalization control. Normalized values greater than 100 represent better predicted performance. The tire performance predictors were determined and compared to the ESBR control. The BA containing polymers detailing advantages in dry traction, winter tractions, ice traction, wet traction, without loss in performance in her areas (i.e fuel economy and treadwear). There was a slight loss in dry handling.

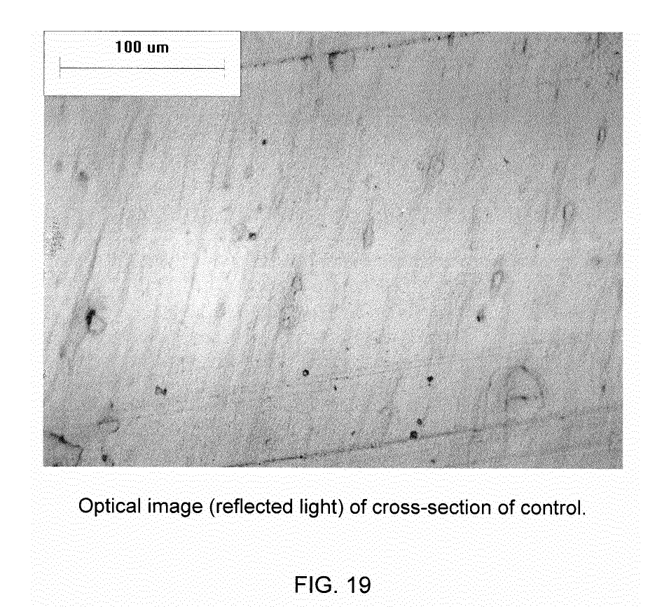

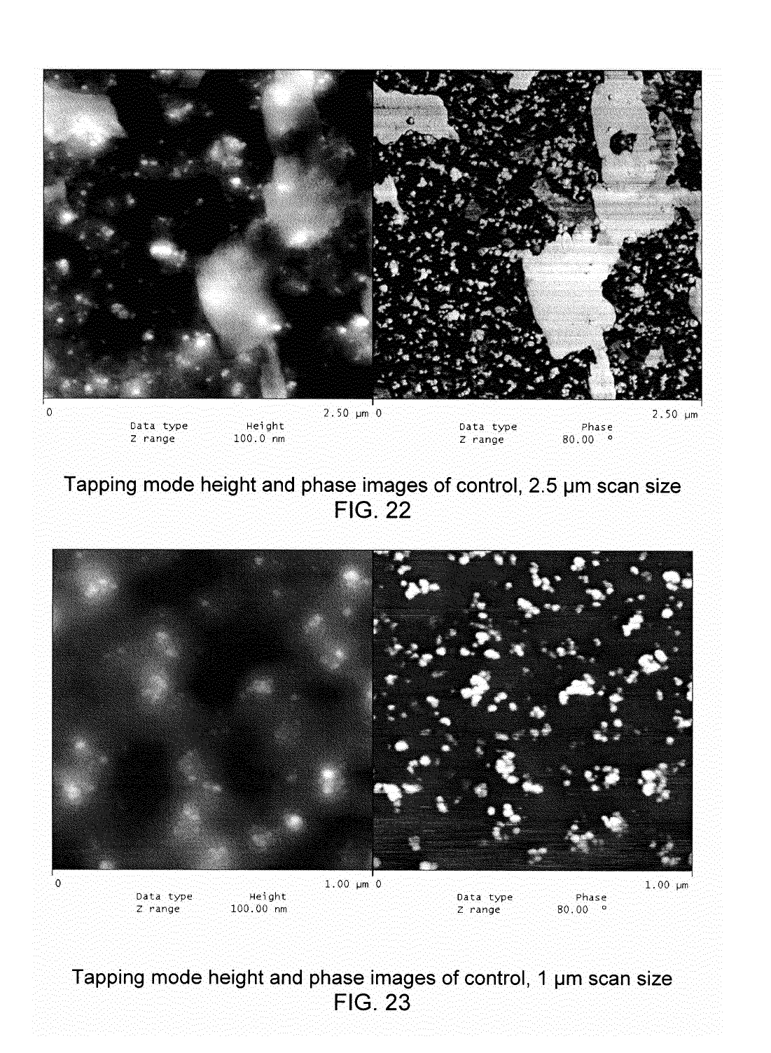

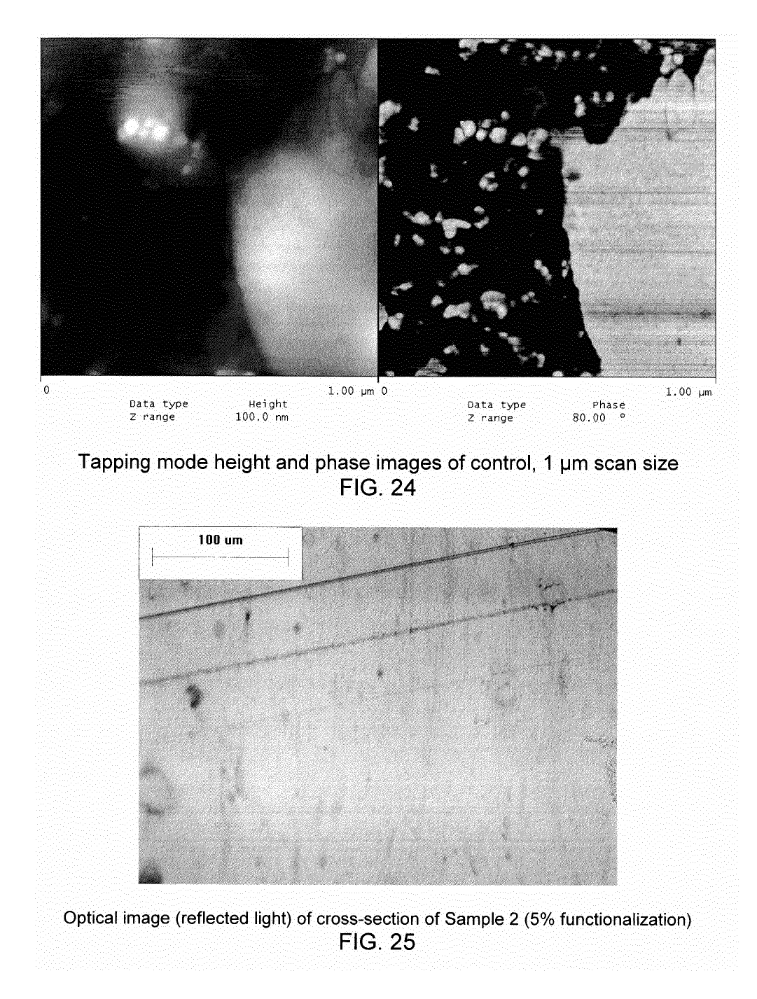

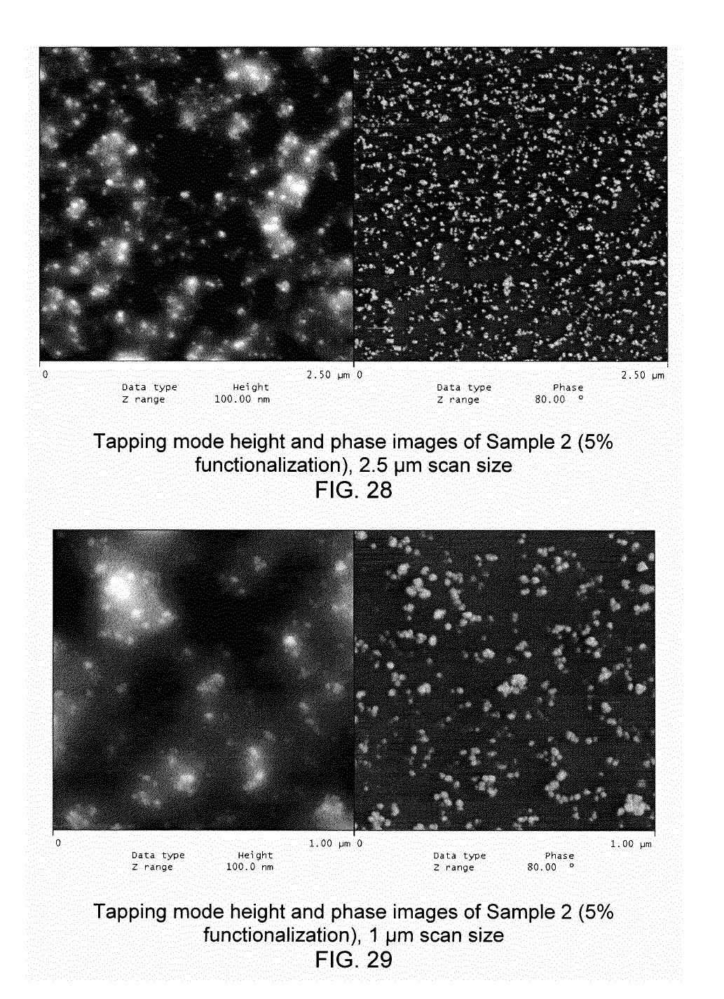

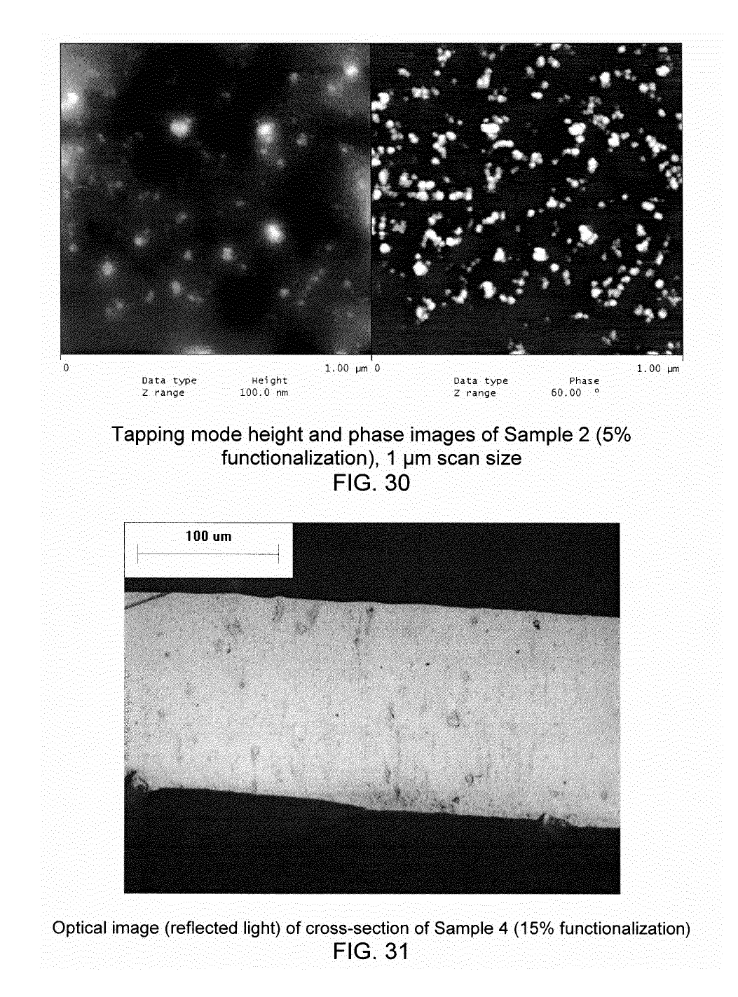

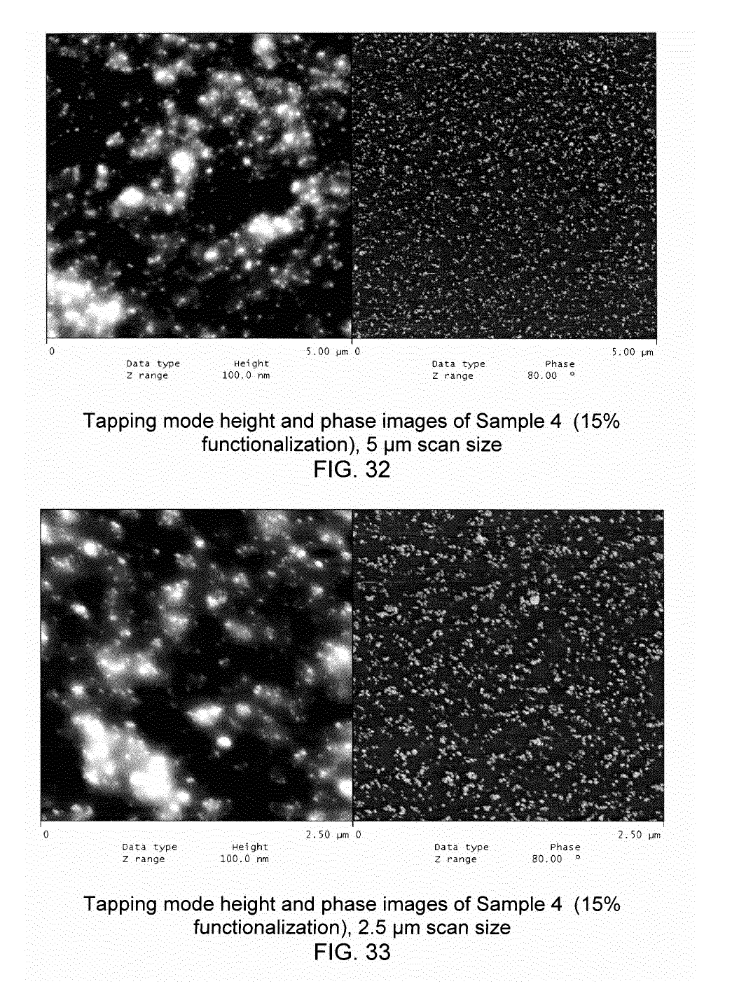

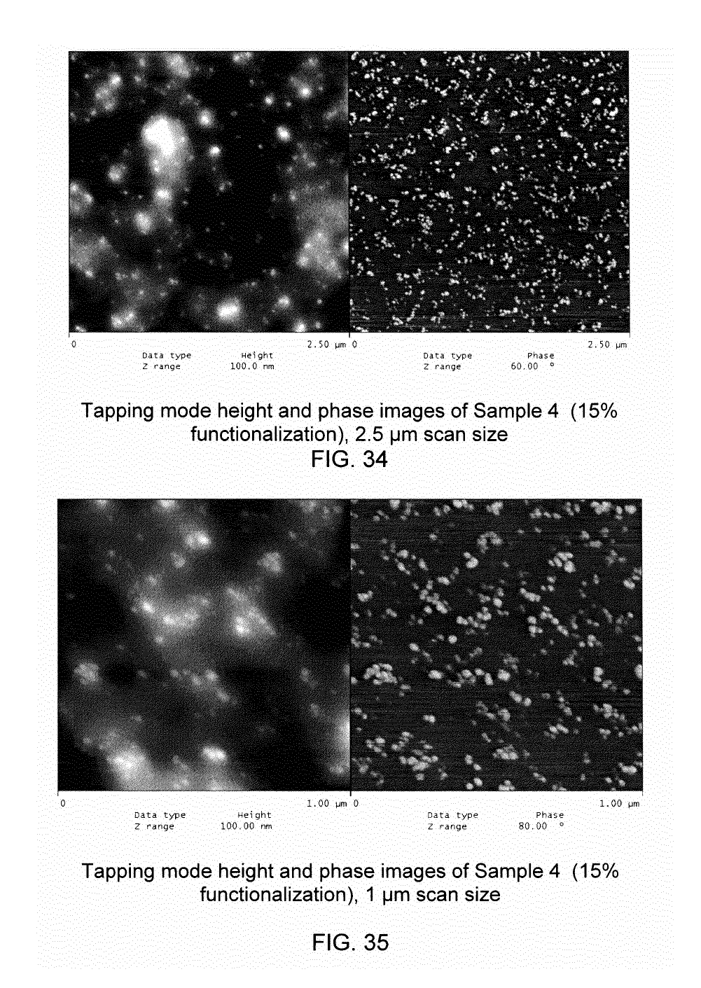

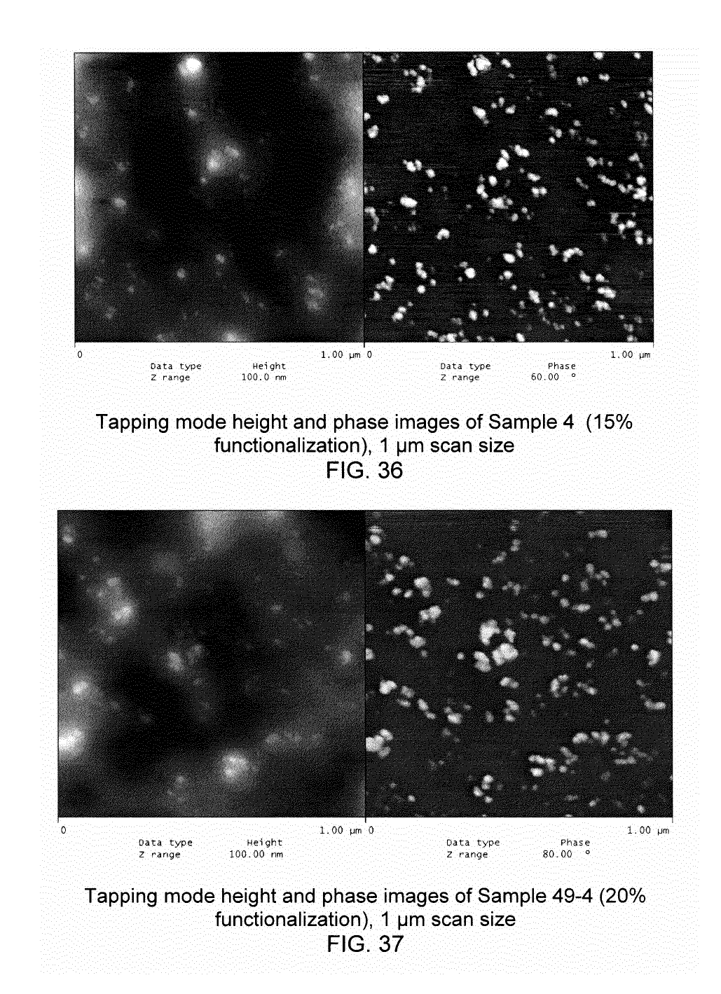

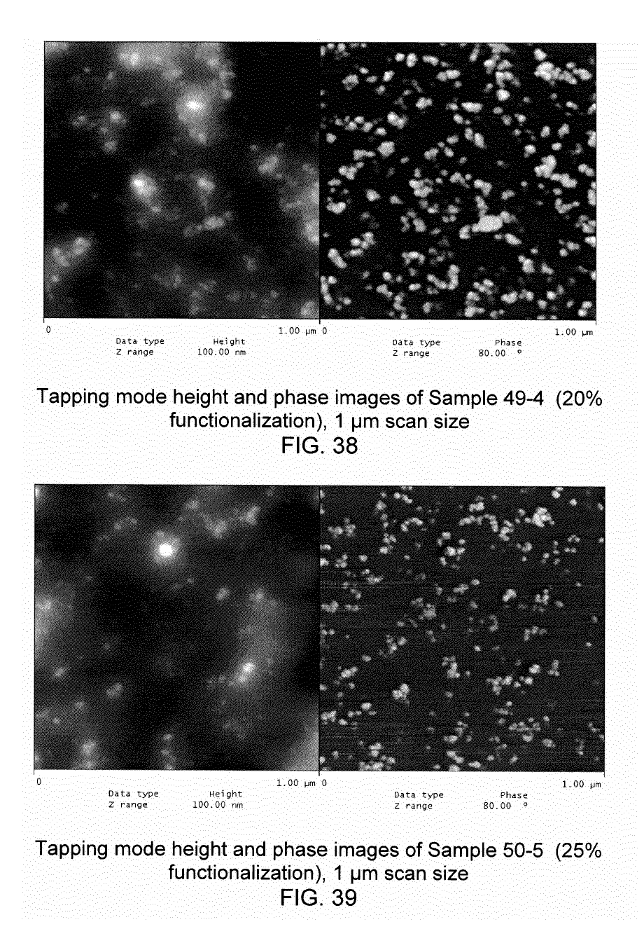

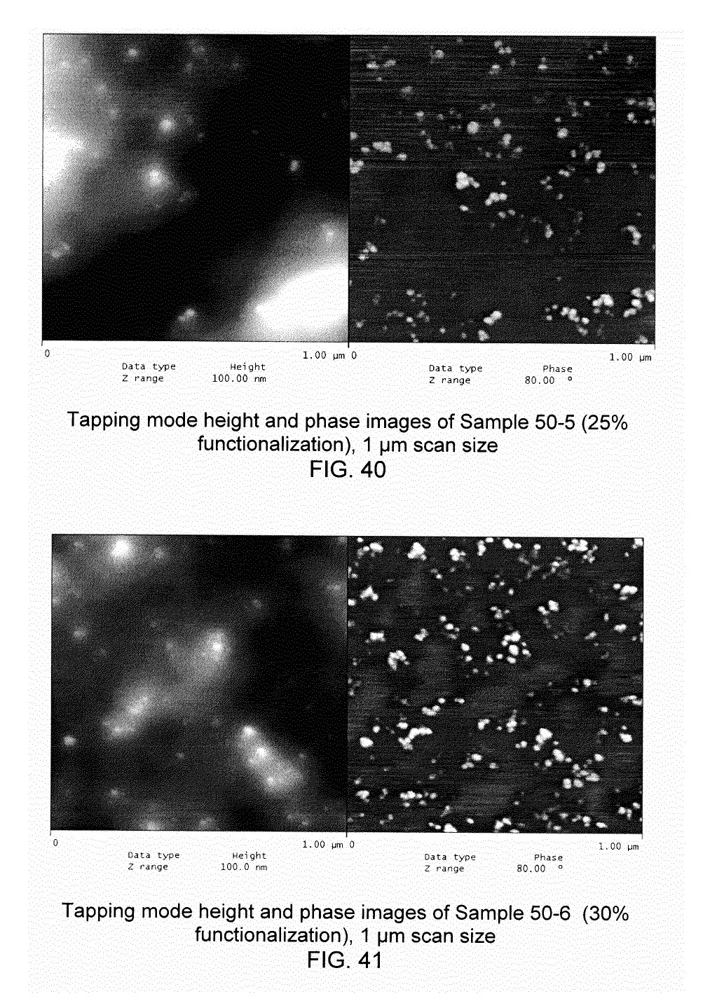

The dispersion of the silica was also monitored. The Atomic Force Microscopy (AFM) and optical images provided in FIGS. 19 to 41 detail how the butyl acrylate interacts with silica at 0%, 5%, 15%, 20%, 25% and 30% polymer functionalization. This ester reaction with silica is confirmed by this AFM dispersion analysis. The photos detailing the chemical filler interaction seen specifically with the deagglomeration of the silica agglomerate.

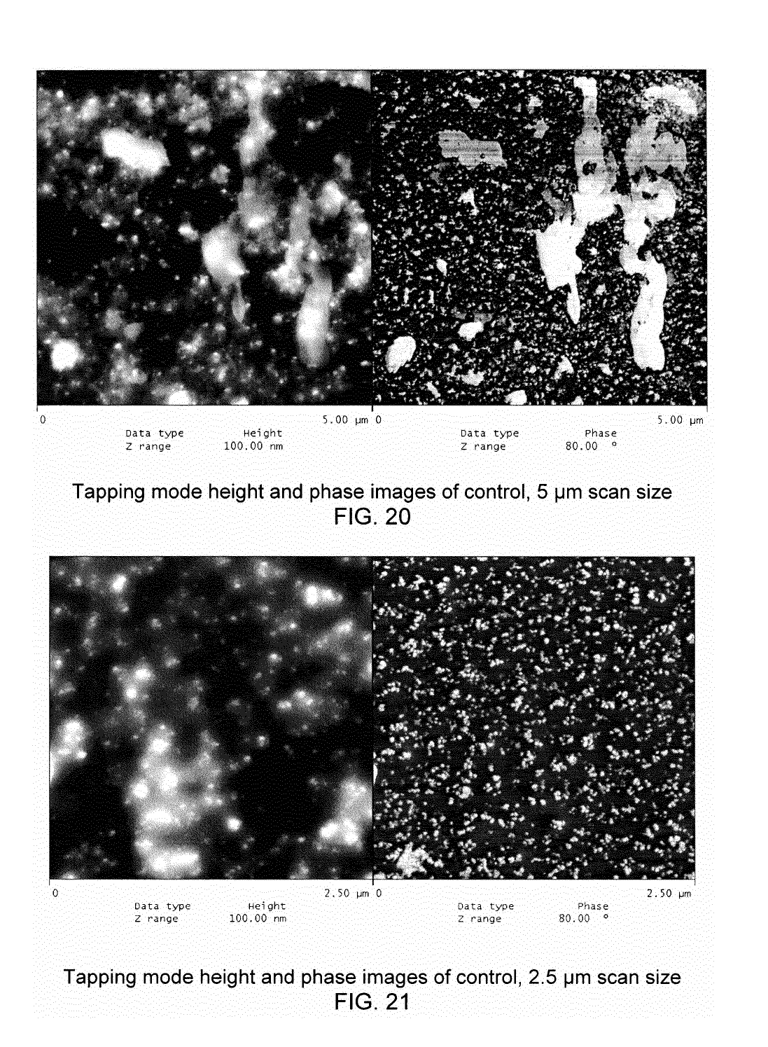

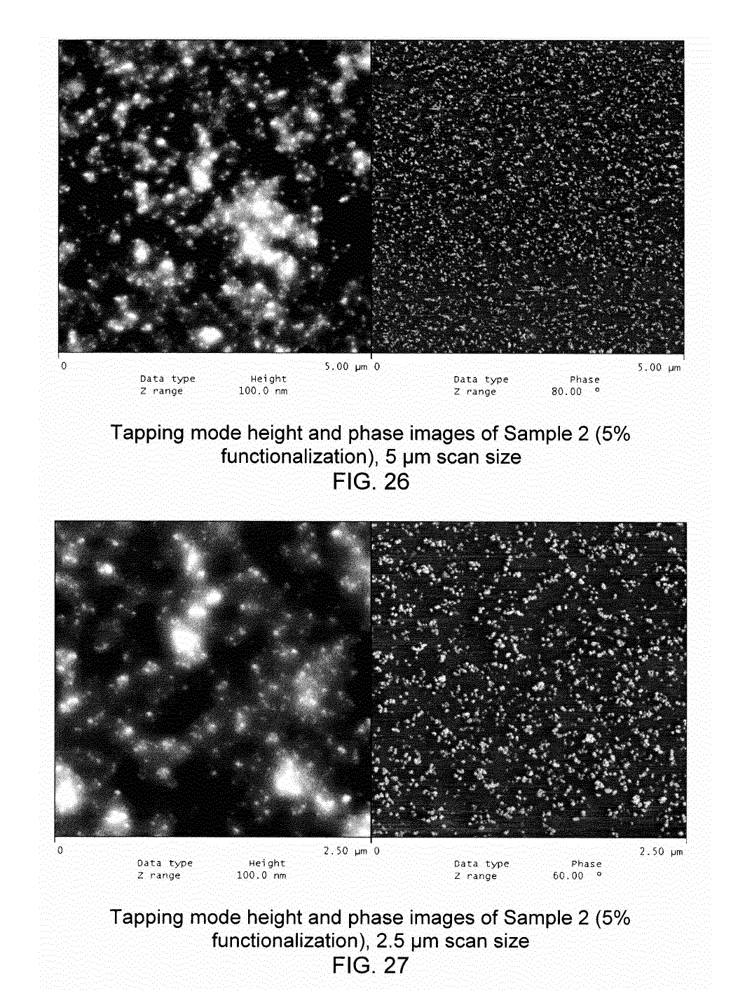

In the AFM images, the silica particles appear as bright areas in the phase images (right side of each figure). As shown in the optical images (FIGS. 19, 25, and 31) and the AFM images (FIGS. 20 to 24, 26 to 30 and 32 to 41) all samples have some variability in the macro-scale dispersion. However, only Sample 1, the control (ESBR with 0% BA) has large bright areas of condensed silane and silica (FIGS. 20 to 24). All of the samples containing butyl acrylate (FIGS. 26 to 30 and 32 to 41) detail finer dispersions silica than the control sample. The silica particles appear to become more dispersed at the higher butyl acrylate levels.

The procedure for the testing involved portions of the milled samples being mounted in a cross-section holder for cryo-facing. A Leica cryomicrotome is used, with sample and diamond knife held at −120° C. The cryo-faced surface of each sample was analyzed with a Veeco Instruments MultiMode AFM. The microscope was operated in tapping-mode with height and phase images collected simultaneously. Silicon cantilevers with a nominal resonance frequency of 190 kHz were used, with medium-light tapping forces characterized by a 0.75 setpoint reduction ratio. Optical images were collected using a digital camera in conjunction with an Olympus BX51 microscopy using polarized, reflected light.

The AFM images are presented as height images (left side of each figure) and phase images (right side of each figure). In the height images, the brighter areas indicate “tall” features while dark areas indicate low areas such as pits or depressions. In the phase images, brighter features generally indicate harder or stiffer domains, while dark areas indicate softer regions. For these samples, some streaking was observed which could have been due to the presence of surfactants in the emulsion polymers or from the butyl acrylate content attracting moisture after preparation of the surfaces.

The data from these examples illustrate the improvements the invention, namely the use of FE-SBR with an acrylate in a silica tread recipe resulting in superior performance than for a similar ESBR composition lacking the functional monomer addition. The present invention using various functionalized ESBRs (FE-SBR) developed and optimized for use in a silica based tire tread formulation being superior. The polymers involved FE-SBR with butyl acrylate (BA) in the example provide and alternatively other C2 to C12 acrylates. Longer chain acrylates and other esters provided similar trends. In other embodiments, the longer chain C12 behaving similar to oil extended grades of polymer. In some instances the Tg of the final polymer decreasing, likely due to the presence of unreacted monomer.

1. A rubber composition, based upon parts by weight per 100 parts by weight of elastomer (phr), comprising:
(A) an elastomer comprised of
(1) 60 to 90 PHR of a copolymer rubber that is the reaction product of:
(a) 10 to 99 weight percent of a conjugated diene monomer which contains from 4 to 8 carbon atoms;
(b) 0 to 70 weight percent of a vinyl substituted aromatic monomer; and
(c) 1 to 30 weight percent of the monomer of the following general formula I: 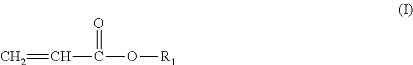
wherein R₁ represents an alkyl group containing from 2 to 12 carbon atoms; and
(2) 10 to 40 PHR of at least one conjugated diene-based elastomer; and
(B) particulate reinforcement comprised of:
(1) 0 to 70 PHR of carbon black; and
(2) 20 to 100 PHR of silica; and
(C) 1 to 10 PHR of silane based coupling agent.

2. The rubber composition of claim 1 wherein said conjugated diene monomer is 1,3 butadiene and the vinyl substituted aromatic monomer is styrene.

3. The rubber composition of claim 1 wherein said conjugated diene-based elastomer is a high-cis polybutadiene.

4. The rubber composition of claim 1 wherein the Tg of the copolymer rubber ranges from −25° C. to −65° C.

5. The rubber composition of claim 1 wherein the rubber composition has a chemical reaction where the result is a reaction of the elastomer with silica.

6. The rubber composition of claim 1 wherein the rubber composition has a chemical reaction where the results are polymer-filler reactions at a ratio of 3:1 for chemical reactions with the silica via the ester group versus the silane based coupling agent.

7. The rubber composition of claim 1 in the form of a tire tread.

8. The rubber composition of claim 1 wherein the elastomer has a repeating unit of monomer from formula (I).

9. The rubber composition of claim 1 wherein the elastomer is comprised of:
(1) 70 to 80 PHR of a copolymer rubber that is the reaction product of:
(a) 10 to 99 weight percent of a conjugated diene monomer which contains from 4 to 8 carbon atoms;
(b) 0 to 70 weight percent of a vinyl substituted aromatic monomer; and
(c) 5 to 15 weight percent of the monomer of the following general formula I: 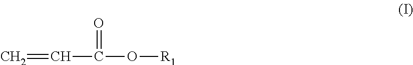
wherein R₁ represents an alkyl group containing from 2 to 12 carbon atoms; and
(2) 20 to 30 PHR of at least one conjugated diene-based elastomer.

10. The rubber composition of claim 1 wherein the particulate reinforcement is comprised of (1) 12 to 25 PHR of carbon black; and (2) 45 to 80 PHR of silica; and 3 to 7.5 PHR of silane based coupling agent.

11. The rubber composition of claim 1 wherein the monomer of general formula I is selected from the group consisting of one or more of a C2 acrylate, a C3 acrylate, a C4 acrylate, a C5 acrylate, a C6 acrylate, a C7 acrylate, a C8 acrylate, a C9 acrylate, a C10 acrylate, a C11 acrylate, or a C12 acrylate.

12. The rubber composition of claim 1 wherein the Mooney viscosity of the copolymer rubber ranges from 15 to 65 (ML4@100 C).

13. The rubber composition of claim 1 wherein the weight average molecular weight is between 260,000 and 410,000 g/mol.

14. The rubber composition of claim 1 where the ratio of silica to carbon black is 1:1.

15. The rubber composition of claim 1 where the ratio of silica to carbon black is 3:1.
